(19) United States
(12) Patent Application Publication
(10) Pub. No.: US 2003/0169972 A1
(43) Pub. Date: Sep. 11, 2003

(54) Method of inserting optical system into optical fibers in bulk and bulk optical fiber structure

(76) Inventor: Stuart T. Stanton, Bridgewater, NJ (US)

Correspondence Address: HARNESS, DICKEY & PIERCE, P.L.C., P.O. BOX 8910, RESTON, VA, 20195, US

(21) Appl. No.: 10/092,304

(22) Filed: Mar. 7, 2002

(51) Int. Cl. G02B 6/40; G02B 6/04

(52) U.S. Cl. 385/54; 385/115

(57) ABSTRACT

In the method of inserting an optical system into optical fibers in bulk, the position of a portion of optical fibers in a bundle of optical fibers is fixed. Then, the bundle of optical fibers is sliced at the fixed portion to form a first and second bundle of optical fibers, and an optical system such as a tap optical system that preserve fiber relationship integrity is positioned between the first and second bundles of optical fibers.

### BACKGROUND OF THE INVENTION

1. Field of the Invention

The present invention relates to handling optical fibers in bulk; and more particularly, inserting an optical system into optical fibers. Even more particularly, the present invention relates to a method of tapping (in or out) optical fibers in a telecommunication system and the tapping structure.

2. Description of Related Art

Typically optical fibers are handled on an individual basis when inserting an optical system. For example, even though a bundle of 64 fibers is presented for tapping, each fiber is individually tapped. One such process involves splicing a y-branch fiber onto one of the fibers in the bundle, repeating the splicing operation for each of the other fibers in the bundle, and then arraying the resulting spliced fibers. The spliced in fibers are each delivered to, for example, a respective detector in an array package at some other location.

As will be appreciated from the above description, handling optical fibers individually is an extremely time consuming and costly process. And, as the number of fibers in bundles increases to 256 or 1024, the time and cost required to insert an optical system into the optical fibers only becomes worse.

### SUMMARY OF THE INVENTION

The method according to the present invention provides for inserting an optical system into optical fibers in bulk, instead of on an individual basis. In the method, a portion of a bundle (arrayed or random) of optical fibers have their position fixed. In one embodiment, the portion of the optical fibers are potted in an epoxy. In another embodiment, mechanical means are used to fix the position of the optical fibers. Subsequently, the fixed portion of the optical fibers is sliced to form first and second bundles of optical fibers. Thereafter, an optical system is positioned between the first and second bundles. For example, optics for tapping out a percentage of the light traveling from the optical fibers in the first bundle to the second bundle is positioned between the first and second bundles to monitor the power of the signal traveling through each bundle.

Because the optical fibers are handled in bulk, operations such as tapping the optical fibers can be performed efficiently—saving both time and money. For telecommunications based applications, the method preserves the fiber relationship integrity as well as the fiber signal purity when tapping (in or out) the optical fibers in the telecommunications system. Accordingly, the present invention has telecommunication applications for wave division multiplexing, single mode fiber, optical spectrum monitoring, etc.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIGS. 1-3A illustrate the process steps in the method of inserting an optical system into optical fibers in bulk according to one embodiment of the present invention;

FIG. 3B illustrates another embodiment of an optical system according to the present invention;

FIGS. 4-6 illustrate the process steps in the method of inserting an optical system into optical fibers in bulk according to another embodiment of the present invention; and

FIGS. 7 and 8 illustrate other embodiments of mechanical means for creating the optical fiber bundles.

### DETAILED DESCRIPTION OF THE EMBODIMENTS

FIGS. 1-3A illustrate the process steps in the method of inserting an optical system into optical fibers in bulk according to one embodiment of the present invention. As shown in FIG. 1, a bundle of optical fibers 10 is potted in an epoxy 12 (hereinafter referred to as the potted portion 12), such as product #330 made by Epoxy Technology, according to any well-known technique to fix the position of the optical fibers. The arrangement of the optical fibers may be systematic (e.g., an array—square, hexagonal, etc.) or random. Generally, a closed-packed hexagonal arrangement minimizes the optical field size.

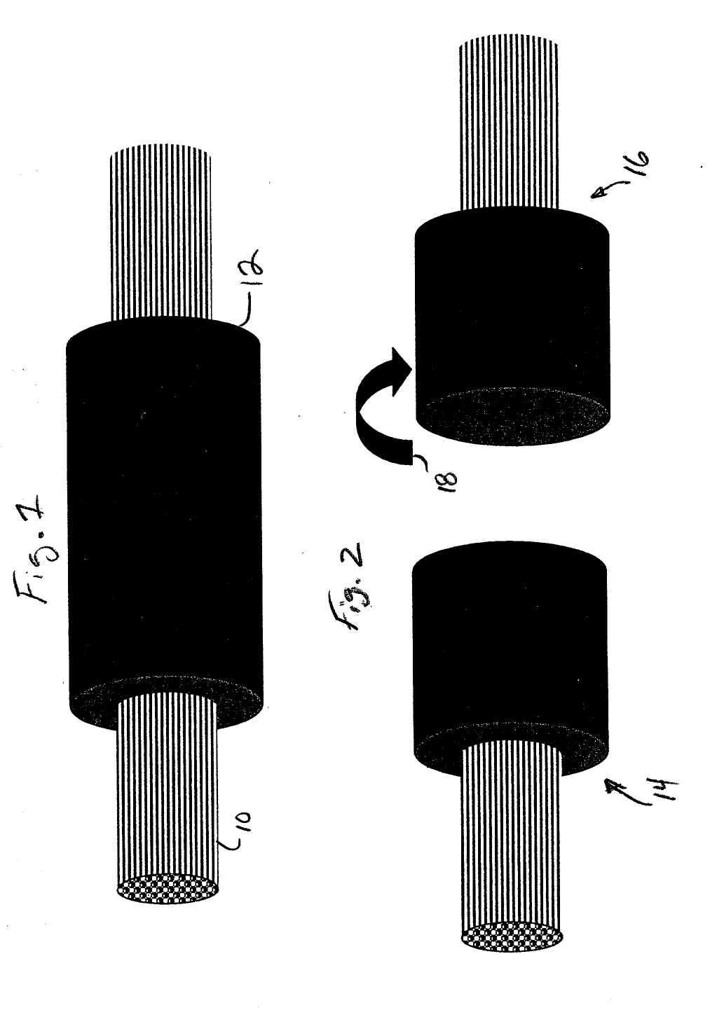

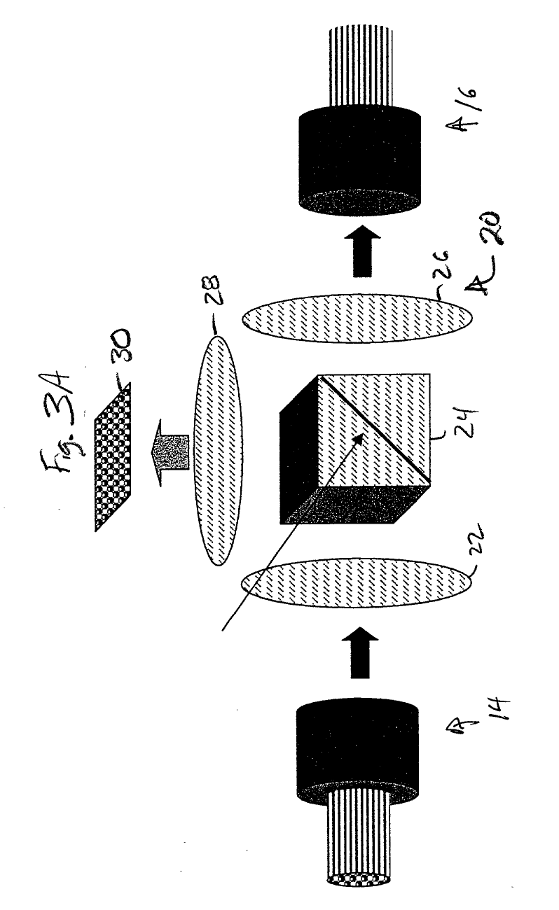

As shown in FIG. 2, the potted portion 12 is sliced using, for example, a diamond saw to create a first bundle 14 and a second bundle 16. The faces of the first and second bundles 14 and 16 created by slicing the potted portion 12 are then polished. Because of the optical system used in the next step, the second bundle 16 is rotated 180 degrees with respect to the first bundle 14 as indicated by the arrow 18, but this rotation is optional depending on the optical system used.

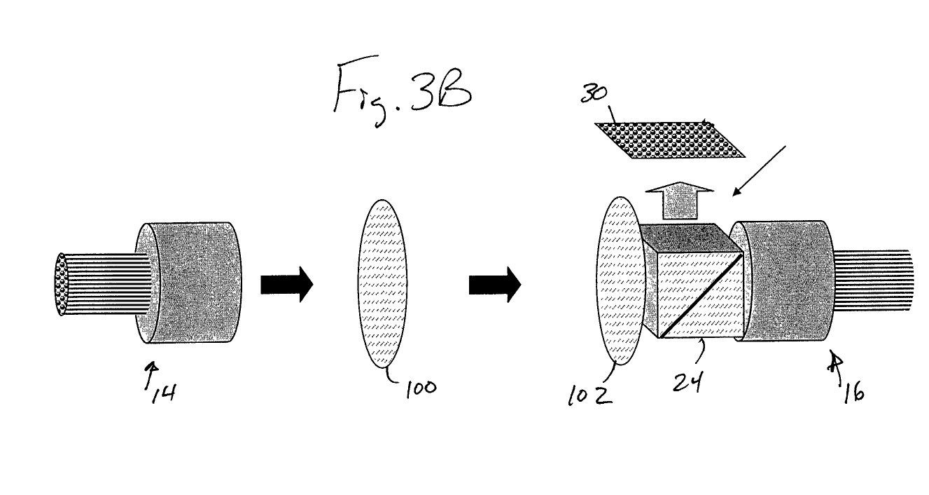

Then, as shown in FIG. 3A, an optical system 20 is disposed between the first and second bundles 14 and 16. The optical system 20 is a 1× imaging system that rotates the received image by 180 degrees at the output side. Accordingly, the combination of the optical system 20 and the positioning of the first and second bundles 14 and 16 relative to one another preserves the fiber relationship integrity; namely, results in the light output from an optical fiber in the first bundle 14 to input into the corresponding optical fiber in the second bundle 16 regardless of the arrangement of the optical fibers. In addition, fiber signal purity is maintained; namely, a desired signal-to-noise ratio given such consideration as dispersion and cross-talk are also achieved. Accordingly, the present invention has telecommunication applications for wave division multiplexing, single mode fiber, optical spectrum monitoring, etc.

As shown in FIG. 3A, one embodiment of the optical system 20 includes a cube beam splitter 24 (e.g., of BK7 glass) disposed between the first and second bundles 14 and 16. A coating on the hypotenuse of the cube beam splitter 24 provides a small (e.g., 1%) controlled sample of the images of the fibers and redirects the sample of the images toward a detector array 30. This coating can be made very insensitive to polarization and wavelength, according to any well-known technique. A detector array 30 in one embodiment is an array of detectors having one detector pixel per optical fiber in the first bundle 14. In another embodiment, the detector array 30 is a camera or equivalent high-resolution detector array capable of imaging distinct image of an arbitrary arrangement of optical fibers. Other possible detectors or alternatives to the detector include a near-infrared camera, an array of infrared PIN diodes, a third bundle of optical fibers (single or multi-mode), a single large area diode, and a single diode having a moving aperture for selectively monitoring a single fiber. The branch of the optical system 20 that goes to the detector array 30 can be optically poor since the active area of the detector array 30 may be large and blurry images are allowed. The spots (i.e., the sample image from each fiber) need only be separated well, which corresponds to a poor image of, for example, 9 micron fibers that are 125 microns apart.

As further shown in FIG. 3A, the optical system 20 includes a first lens system 22 disposed between the first bundle 14 and the beam splitter 24, a second lens system 26 disposed between the beam splitter 24 and the second bundle 16, and a third lens system 28 disposed between the beam splitter 24 and the detector array 30. While the first, second and third lens systems 22, 26 and 28 have been illustrated as single lenses for ease of illustration, it should be understood that each of the first, second and third lens systems 22, 26 and 28 can include one or more lenses depending on the desired design parameters. For example, if reasonable broadband characteristics are desired, the first, second and third lens systems 22, 26 and 28 are achromatic pairs.

FIG. 3B illustrates another example of a tapping out optical system, wherein like reference numerals designate like components. As shown, a first and second lens system 100 and 102 are disposed between the first bundle 14 and the beam splitter 24. This arrangement eliminates the need for a lens system between the beam splitter 24 and the second bundle 16, and also between the beam splitter 24 and the detector 30. As with the optical system 20 of FIG. 3A, the first and second lens systems 100 and 102 in the optical system of FIG. 3B are established based on desired design parameters.

While the optical system 20 inserted into the bundle of optical fibers 10 was described as a tap-out optical system, it should be understood that the present invention is not limited to having a tap-out optical system inserted into the bundle of optical fibers. Instead, any known optical system, such as a tap-in optical system, could be inserted into the bundle of optical fibers 10 using the method according to the present invention.

The present invention provides a method for inserting an optical system into optical fibers in bulk and a resulting structure that does not require lens arrays and critical alignment of many distinct beams in free space. A regular array of fiber is also not required. Furthermore, the optical system uses only a few large-scale optics with limited degrees-of-freedom to align. And, because the optical fibers are not handled on an individual basis, handling time and cost are greatly reduced. In addition, the addition of more optical fibers to a bundle does not greatly affect the time and cost of handling the optical fibers.

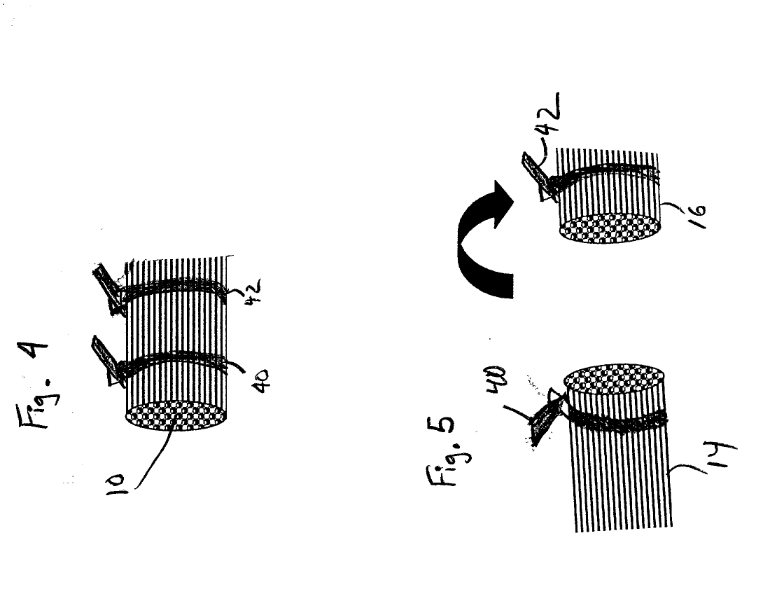

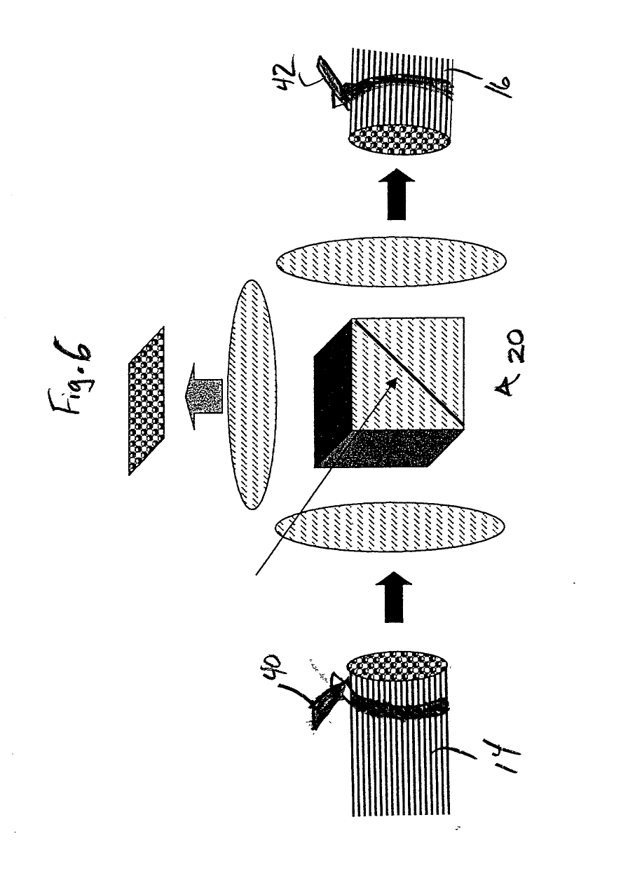

FIGS. 4-6 illustrate the process steps in the method of handling optical fibers in bulk according to another embodiment of the present invention. As shown in FIGS. 4-6. the method according to this embodiment does not differ from the method of the previous embodiment, except that the position of the optical fibers in the bundle is not fixed using an epoxy. Instead, as shown in FIG. 4, the position of the optical fibers is mechanically fixed. For example, first and second tie downs 40 and 42 strap the optical fiber bundle 10 together. Then, as shown in FIG. 5, the optical fiber bundle 10 is sliced between the first and second tie downs 40 and 42 to create the first and second bundles 14 and 16. The remainder of the method according to this embodiment is the same as the previously described embodiment, and therefore, will not be repeated for the sake of brevity.

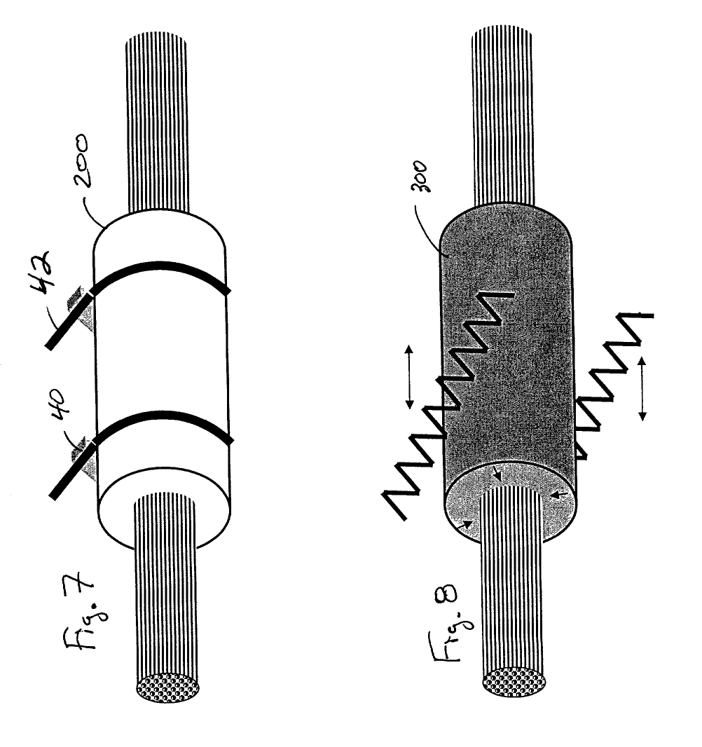

While the mechanical device used to fix the position of the optical fiber bundle 10 in the above described embodiment was given as the first and second tie downs 40 and 42, it should be appreciated that the present invention is not limited to this mechanical means of fixing the position of the optical fiber bundle 10. Instead, any well-known mechanical means of fixing the position of an optical fiber bundle, such as a soft PVC and tied downs as shown in FIG. 7 or a wire shrink wrap as shown in FIG. 8, could be used.

As shown in FIG. 7, a soft insulating material 200 such as soft PVC surrounds the bundle of optical fibers 10, and the first and second tie downs 40 and 42 are attached around the soft insulating material 200. The soft insulating material prevents the pressure, applied by the first and second tie downs 40 and 42 from bending the optical fibers 10.

As shown in FIG. 8, a shrink wrap material 300 is placed around the plurality of optical fibers 10, and then heat (as represented by the saw-toothed lines) is applied to the shrink wrap material 300 to shrink the shrink wrap material 300 around the plurality of optical fibers 10. This fixes the position of the plurality of optical fibers 10.

The invention being thus described, it will be obvious that the same may be varied in many ways. For example, it will be understood that the present invention is not limited to the examples of the mechanical means for fixing the position of the optical fibers described above. Such variations are not to be regarded as a departure from the spirit and scope of the invention, and all such modifications are intended to be included within the scope of the following claims.

We claim:

1. A method of inserting an optical system into optical fibers in bulk, comprising:
fixing the position of a portion of optical fibers in a bundle of optical fibers;
slicing the bundle of optical fibers at the portion to form a first and second bundle of optical fibers; and
positioning an optical system between the first and second bundles of optical fibers.

2. The method of claim 1, wherein the fixing step includes embedding the portion of the optical fibers in a solid.

3. The method of claim 2, wherein the slicing step cuts through the solid.

4. The method of claim 1, wherein the fixing step fixes the portion of the optical fibers in an array.

5. The method of claim 1, wherein the fixing step uses mechanical means on either end of the portion of the optical fibers to fix the position of the portion of the optical fibers.

6. The method of claim 1, after the slicing step, further comprising:
polishing exposed ends of at least one of the first and second bundles of optical fibers.

7. The method of claim 1, wherein the positioning step positions the optical system and the first and second bundles of optical fibers such that the second bundle of optical fibers is rotated 180 degrees with respect to the first bundle of optical fibers along an optical axis of the optical system, and the optical system inverts an image output by the first bundle of optical fibers.

8. The method of claim 1, wherein the optical system includes a first lens system including at least one lens, a beam splitter and a second lens system including at least one lens.

9. The method of claim 8, wherein the beam splitter splits off about 1% of an incident beam.

10. The method of claim 8, wherein the optical system further includes a detector positioned to receive a beam split off by the beam splitter.

11. The method of claim 1, wherein
the fixing step includes embedding the portion of the optical fibers in a solid;
the slicing step cuts through the solid; and
the positioning system positions the optical system and the first and second bundles of optical fibers such that the second bundle of optical fibers is rotated 180 degrees with respect to the second bundle of optical fibers along and optical axis of the optical system, and the optical system inverts an image output by the first bundle of optical fibers.

12. A bulk optical fiber structure, comprising:
a first bundle of optical fibers having first ends fixed in a first position;
a second bundle of optical fibers having second ends fixed in a second position associated with the first position; and
an optical system disposed between the first and second bundles of optical fibers.

13. The structure of claim 12, wherein the first and second ends are embedded in first and second solids, respectively.

14. The structure of claim 12, wherein the first and second positions are first and second arrays, respectively.

15. The structure of claim 12, further comprising:
first mechanical means fixing the first ends in the first position; and
second mechanical means fixing the second ends in the second position.

16. The structure of claim 12, wherein at least one of the first and second ends are polished.

17. The structure of claim 12, wherein the optical system and the first and second bundles of optical fibers are positioned such that the second bundle of optical fibers is rotated 180 degrees with respect to the first bundle of optical fibers along an optical axis of the optical system, and the optical system inverts an image output by the first bundle of optical fibers.

18. The structure of claim 12, wherein the optical system includes a first lens system including at least one lens, a beam splitter and a second lens system including at least one lens.

19. The structure of claim 18, wherein the beam splitter splits off about 1% of an incident beam.

20. The structure of claim 18, wherein the optical system further includes a detector positioned to receive a beam split off by the beam splitter.

21. The structure of claim 12, wherein
the first and second ends are embedded in first and second solids, respectively.
the optical system and the first and second bundles of optical fibers are positioned such that the second bundle of optical fibers is rotated 180 degrees with respect to the first bundle of optical fibers along an optical axis of the optical system, and the optical system inverts an image output by the first bundle of optical fibers.

22. The structure of claim 12, wherein the second position is an inverse of the first position.

23. A method of tapping optical fibers in a telecommunication system, comprising:
fixing the position of a portion of optical fibers in a bundle of optical fibers;
slicing the bundle of optical fibers at the portion to form a first and second bundle of optical fibers; and
positioning a tap optical system that preserves fiber relationship integrity between the first and second bundles of optical fibers.

24. The method of claim 23, wherein the positioning step positions a tap optical system that preserves fiber signal purity.

25. The method of claim 23, wherein the tap optical system is a tap-in optical system.

26. The method of claim 23, wherein the tap optical system is a tap-out optical system.

27. A bulk optical fiber tap structure, comprising:
a first bundle of optical fibers having first ends fixed in a first position;
a second bundle of optical fibers having second ends fixed in a second position associated with the first position; and
a tap optical system disposed between the first and second bundles of optical fibers, the tap optical system preserving fiber relationship integrity from the first bundle to the second bundle.

28. The structure of claim 27, wherein the tap optical system preserves fiber signal purity.

29. The structure of claim 27, wherein the tap optical system is a tap-in optical system.

30. The structure of claim 23, wherein the tap optical system is a tap-out optical system.
